(19) United States
(12) Patent Application Publication
(10) Pub. No.: US 2017/0193704 A1
(43) Pub. Date: Jul. 6, 2017

(54) CAUSING PROVISION OF VIRTUAL REALITY CONTENT

(71) Applicant: Nokia Technologies Oy, Espoo (FI)

(72) Inventors: Jussi Artturi Leppänen, Tampere (FI); Antti Johannes Eronen, Tampere (FI); Arto Juhani Lehtiniemi, Lempaala (FI); Francesco Cricri, Tampere (FI); Miikka Tapani Vilermo, Siuro (FI)

(21) Appl. No.: 15/368,503

(22) Filed: Dec. 2, 2016

(30) Foreign Application Priority Data
Dec. 11, 2015 (GB) 1521917.3

(51) Int. Cl. G06T 19/00; H04N 13/02; G06F 3/16; G06F 3/01; G06T 15/20

(52) U.S. Cl. CPC G06T 19/006; G06F 3/011; G06T 15/20; G06F 3/165; H04N 13/0278; G06T 2200/04; G06T 2215/16; G06T 2219/024

(57) ABSTRACT

This specification describes a method comprising causing provision of a first version of virtual reality content to a first user via first portable user equipment located at a first location and having a first orientation, the virtual reality content being associated with a second location and a second orientation, the first version of the virtual reality content being rendered for provision via the first user equipment in dependence on the first location relative to the second location and the first orientation relative to the second orientation.

### FIELD

This specification relates generally to the provision of virtual reality content.

### BACKGROUND

When experiencing virtual reality (VR) content, such as a VR computer game, a VR movie or “Presence Capture” VR content, users generally wear a specially-adapted head-mounted display device (which may be referred to as a VR device) which renders the visual content. An example of such a VR device is the Oculus Rift®, which allows a user to watch 360-degree visual content captured, for example, by a Presence Capture device such as the Nokia OZO camera.

In addition to a visual component, VR content typically includes an audio component which may also be rendered by the VR device (or server computer apparatus which is in communication with the VR device) for provision via an audio output device (e.g. earphones or headphones).

### SUMMARY

In a first aspect, this specification describes a method comprising causing provision of a first version of virtual reality content to a first user via first portable user equipment located at a first location and having a first orientation, the virtual reality content being associated with a second location and a second orientation, the first version of the virtual reality content being rendered for provision via the first user equipment in dependence on the first location relative to the second location and the first orientation relative to the second orientation.

The second location may be defined by a location of second portable user equipment for providing a second version of the virtual reality content to a second user. In such examples, the method may comprise causing the first portable user equipment to capture visual content from a field of view associated with the first orientation and, when the first user equipment is oriented towards the second user equipment worn by the second user, causing provision to the user of captured visual content representing the second user in conjunction with the first version of the virtual reality content.

In other examples, the virtual reality content may be associated with a fixed geographic location and orientation.

The virtual reality content may be derived from plural content items each derived from a different one of plural content capture devices arranged in a two-dimensional or three-dimensional array. The first version of the virtual reality content may comprise a portion of a cylindrical panorama created using visual content of the plural content items, the portion of the cylindrical panorama being dependent on the first location relative to the second location and the first orientation relative to the second orientation. The portion of the cylindrical panorama may be dependent on a field of view associated with the first user equipment. The portion of the cylindrical panorama which is provided to the first user via the first user equipment may be sized such that it fills at least one of a width and a height of a display of the first user equipment.

The first version of the virtual reality content may be provided in combination with content captured by a camera module of the first user equipment.

The virtual reality content may comprise audio content comprising plural audio sub-components each associated with a different location around the second location. The method may further comprise at least one of: when it is determined that the distance between the first and second locations is above a threshold, causing provision of the audio sub-components to the user via the first user equipment such that they appear to originate from a single point source; and when it is determined that the distance between the first and second locations is below a threshold, causing provision of the virtual reality audio content to the user via the first user equipment such that sub-components of the virtual reality audio content appear to originate from different directions around the first user.

In examples in which the virtual reality content comprises audio content, the method may further comprise, when it is determined that the distance between the first and second locations is below a threshold, causing noise cancellation to be provided in respect of sounds other than the virtual reality audio content. Alternatively or additionally, the method may comprise, when it is determined that the distance between the first and second locations is above a threshold, setting a noise cancellation level in dependence on the distance between the first and second locations, such that a lower proportion of external noise is cancelled when the distance is greater than when the distance is less.

In a second aspect, this specification describes apparatus configured to perform any method as described with reference to the first aspect.

In a third aspect, this specification describes computer-readable instructions which, when executed by computing apparatus, cause the computing apparatus to perform any method as described with reference to the first aspect.

In a fourth aspect, this specification describes apparatus comprising at least one processor and at least one memory including computer program code, which when executed by the at least one processor, causes the apparatus to cause provision of a first version of virtual reality content to a first user via first portable user equipment located at a first location and having a first orientation, the virtual reality content being associated with a second location and a second orientation, the first version of the virtual reality content being rendered for provision via the first user equipment in dependence on the first location relative to the second location and the first orientation relative to the second orientation.

The second location may be defined by a location of second portable user equipment for providing a second version of the virtual reality content to a second user. In such examples, the computer program code, when executed by the at least one processor, may cause the apparatus to cause the first portable user equipment to capture visual content from a field of view associated with the first orientation and, when the first user equipment is oriented towards the second user equipment worn by the second user, to cause provision to the user of captured visual content representing the second user in conjunction with the first version of the virtual reality content.

In other examples, the virtual reality content may be associated with a fixed geographic location and orientation.

The virtual reality content may be derived from plural content items each derived from a different one of plural content capture devices arranged in a two-dimensional or three-dimensional array. In such examples, the first version of the virtual reality content may comprise a portion of a cylindrical panorama created using visual content of the plural content items, the portion of the cylindrical panorama being dependent on the first location relative to the second location and the first orientation relative to the second orientation. The portion of the cylindrical panorama may be dependent on a field of view associated with the first user equipment. The portion of the cylindrical panorama which is provided to the first user via the first user equipment may be sized such that it fills at least one of a width and a height of a display of the first user equipment.

The first version of the virtual reality content may be provided in combination with content captured by a camera module of the first user equipment.

The virtual reality content may comprise audio content comprising plural audio sub-components each associated with a different location around the second location. In such examples, the computer program code, when executed by the at least one processor, may cause the apparatus to perform at least one of: when it is determined that the distance between the first and second locations is above a threshold, causing provision of the audio sub-components to the user via the first user equipment such that they appear to originate from a single point source; and when it is determined that the distance between the first and second locations is below a threshold, causing provision of the virtual reality audio content to the user via the first user equipment such that sub-components of the virtual reality audio content appear to originate from different directions around the first user.

In examples in which the virtual reality content comprises audio content, wherein the computer program code, when executed by the at least one processor, may cause the apparatus, when it is determined that the distance between the first and second locations is below a threshold, to cause noise cancellation to be provided in respect of sounds other than the virtual reality audio content. Alternatively or additionally, the computer program code, when executed by the at least one processor, may cause the apparatus, when it is determined that the distance between the first and second locations is above a threshold, to set a noise cancellation level in dependence on the distance between the first and second locations, such that a lower proportion of external noise is cancelled when the distance is greater than when the distance is less.

In a fifth aspect, this specification describes a computer-readable medium having computer-readable code stored thereon, the computer readable code, when executed by a least one processor, cause performance of at least: causing provision of a first version of virtual reality content to a first user via first portable user equipment located at a first location and having a first orientation, the virtual reality content being associated with a second location and a second orientation, the first version of the virtual reality content being rendered for provision via the first user equipment in dependence on the first location relative to the second location and the first orientation relative to the second orientation. The computer-readable code stored on the medium of the fifth aspect may further cause performance of any of the operations described with reference to the method of the first aspect.

In a sixth aspect, this specification describes apparatus comprising means for causing provision of a first version of virtual reality content to a first user via first portable user equipment located at a first location and having a first orientation, the virtual reality content being associated with a second location and a second orientation, the first version of the virtual reality content being rendered for provision via the first user equipment in dependence on the first location relative to the second location and the first orientation relative to the second orientation. The apparatus of the sixth aspect may further comprise means for causing performance of any of the operations described with reference to method of the first aspect.

### BRIEF DESCRIPTION OF THE FIGURES

For a more complete understanding of the methods, apparatuses and computer-readable instructions described herein, reference is now made to the following descriptions taken in connection with the accompanying drawings in which:

FIG. 1 is an example of a system for providing virtual reality (VR) content to one or more users;

FIG. 2 is another view of the system of FIG. 1 which illustrates various parameters associated with the system which are used in the provision of VR content;

FIGS. 3A and 3B illustrate an example of how VR content is provided to a user of the system;

FIGS. 4A to 4D illustrate how changing parameters associated with the system affect the provision of the VR content;

FIGS. 5A and 5B illustrate provision by the system of computer-generated VR content;

FIGS. 6A to 6C illustrate provision by the system of VR content which was created using a presence capture device;

FIGS. 7A to 7C illustrate the provision by the system of audio components of VR content;

FIG. 8 is a flow chart illustrating various operations which may be performed by the system of FIG. 1;

FIGS. 9A and 9B are schematic block diagrams illustrating example configurations of the first UE and the server apparatus respectively of FIG. 1;

FIG. 9C illustrates a physical entity for storing computer readable instructions; and

FIG. 10 is a simplified schematic illustration of a presence capture device including a plurality of content capture modules.

### DETAILED DESCRIPTION

In the description and drawings, like reference numerals may refer to like elements throughout.

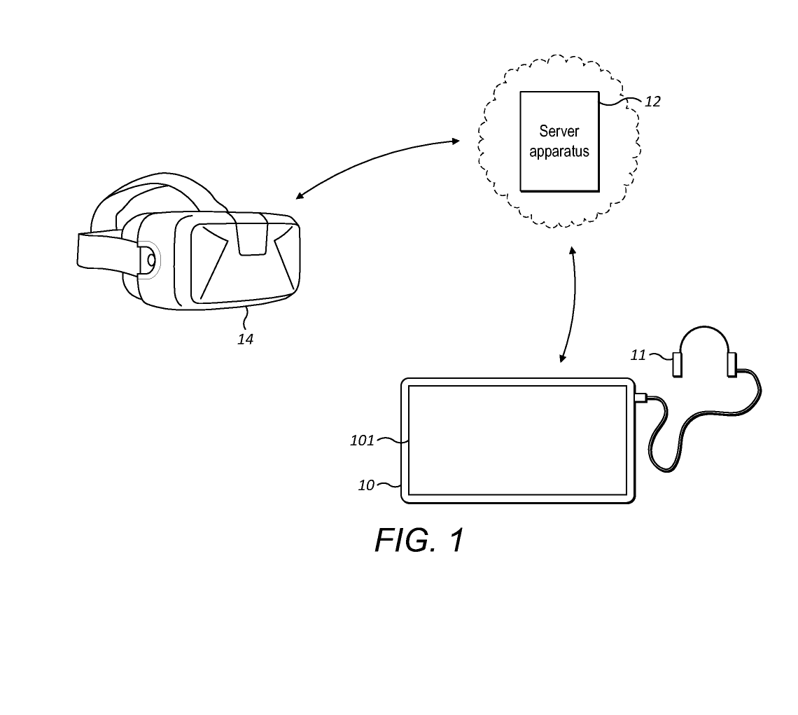

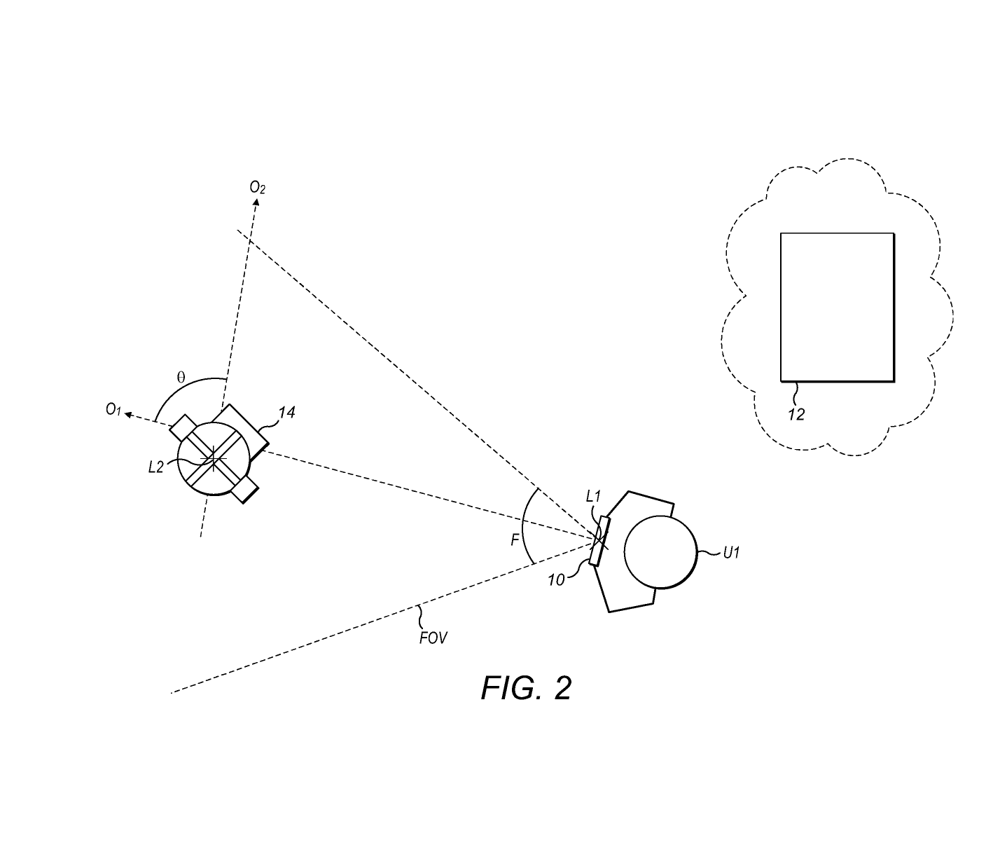

FIGS. 1 and 2 are schematic illustrations of a system 1 for providing VR content for consumption by a user U1. As will be appreciated from the below discussion, VR content generally includes both a visual component and an audio component but, in some implementations, may include just one of a visual component and an audio component. As used herein, VR content may cover, but is not limited to, at least computer-generated VR content, content captured by a presence capture device (presence device-captured content) such as Nokia's OZO camera or the Ricoh's Theta, and a combination of computer-generated and presence-device captured content. Indeed, VR content may cover any type or combination of types of immersive media (or multimedia) content.

The system 1 includes first portable user equipment (UE) 10 configured to provide a first version of VR content to a first user. In particular, the first portable UE 10 may be configured to provide a first version of a visual component of the VR content to the first user via a display 101 of the device 10 and/or an audio component of the VR content via an audio output device 11 (e.g. headphones or earphones). In some instances, the audio output device 11 may be operable to output binaurally rendered audio content.

The system 1 may further include server computer apparatus 12 which, in some examples, may provide the VR content to the first portable UE 10. The server computer apparatus 12 may be referred to as a VR content server and may be, for instance, a games console or any other type of LAN-based or cloud-based server

In the example of FIG. 1, the system 1 further comprises a second portable UE 14 which is configured to provide a second version of the VR content to a second user. The second UE 14 may also receive the VR content for provision to the second user from the computer server apparatus 12.

At least one of the first portable UE 10 and the computer server apparatus 12 may be configured to cause provision of the first version of virtual reality (VR) content to the first user via the first portable UE, which is located at a first location L1 and has a first orientation O1. As is discussed in more detail below, the virtual reality content is associated with a second location L2 and a second orientation O2.

The first version of the virtual reality content is rendered for provision to the first user in dependence on a difference between the first location L1 and the second location L2 and a difference θ between the first orientation O1 and the second orientation O2. Put another way, the first version of the VR content which is provided to the first user is dependent on both the location L1 of the first UE 10 relative to the second location L2 associated with the VR content and the orientation O1 of the first UE 10 relative to the orientation O2 associated with the VR content.

The system 1 described herein enables a first user U1 who is not wearing a dedicated VR device to experience VR content that is associated with a particular location and which may be currently being experienced by a second user U2 who is utilising a dedicated VR UE 14. Put another way, in some examples, the system 1 enables viewing of a VR situation of the second user, who is currently immersed in a “VR world”, by the first user who is outside the VR world.

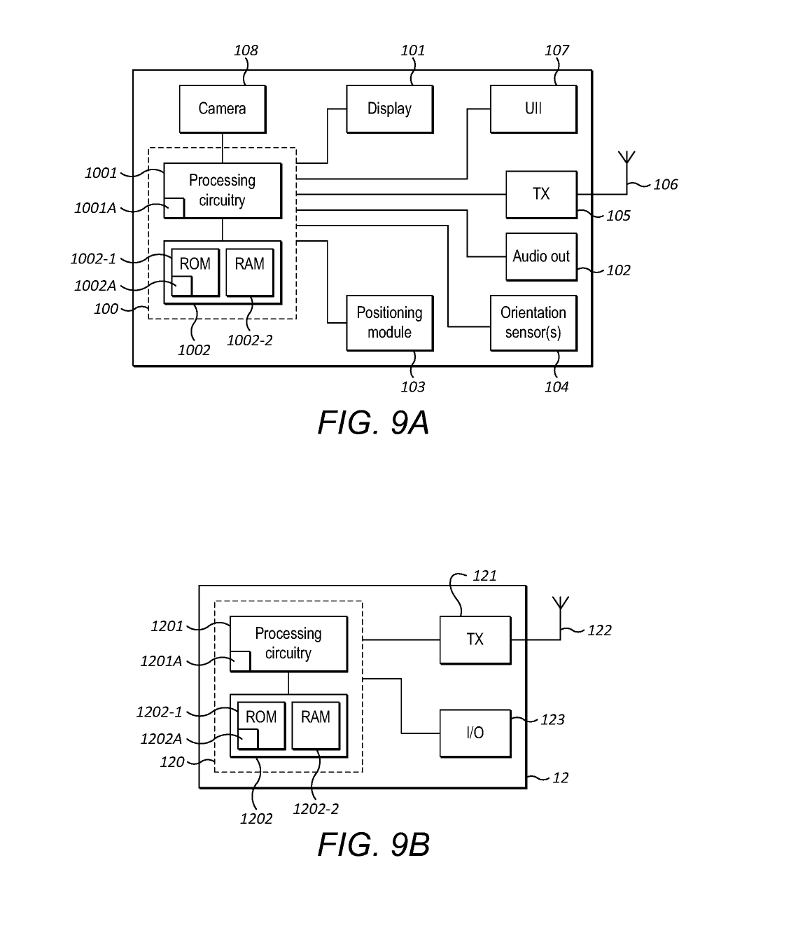

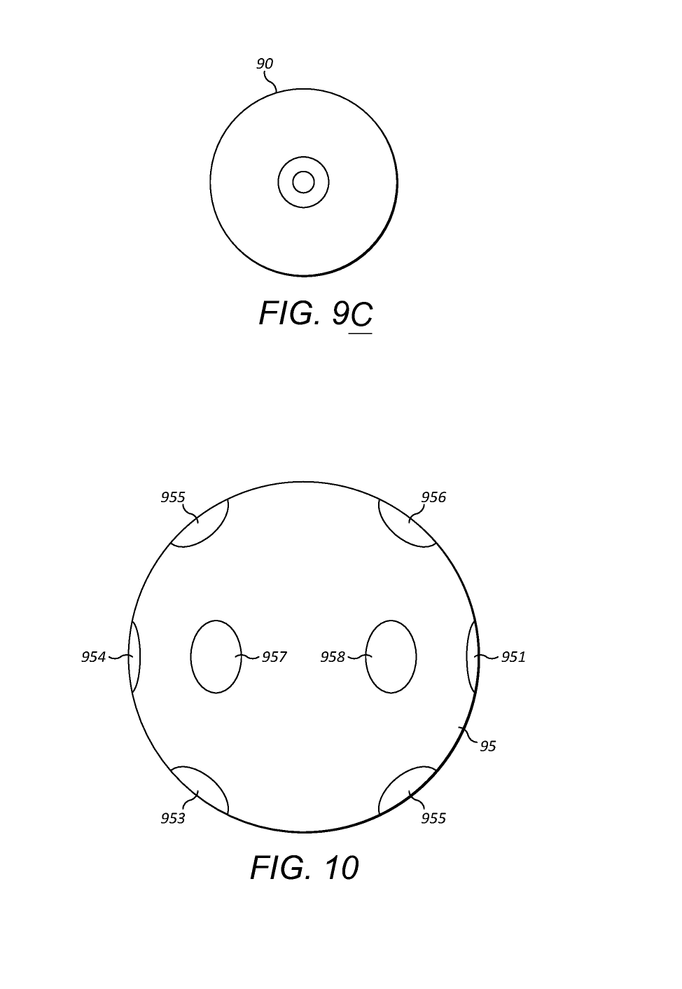

The first UE 10 may, in some examples, be referred to as an augmented reality device. This is because the first UE 10 may be operable to merge visual content captured via a camera module (reference 108, see FIG. 9A) with the first version of the VR content. The first UE 10 may comprise, for instance, a portable display device such as, but not limited to, a smart phone, a tablet computer. In other examples, the first UE 10 may comprise a head-mounted display (e.g. augmented reality glasses) which may operate at least partially under the control of another portable device such as a mobile phone or a tablet computer which also forms part of the first UE 10.

The orientation O1 of the first UE may be the normal to a central part of the reverse side of the display screen (i.e. the opposite side to that which is intended to be view by the user) via which the visual VR content is provided. Where the first UE 10 is formed by two devices, the location L1 of the first UE 10 may be the location of just one of those devices.

In examples in which the system 1 includes the second UE 14, the second UE 14 may be a VR device configured to provide immersive VR content to the second user U2. The second UE may be a dedicated virtual reality device which is specifically configured for provision of VR content (for instance Oculus Rift®) or may be a general-purpose device which is currently being utilised to provide immersive VR content (for instance, a smartphone utilised with a VR mount).

The version of the VR content which is provided to the second user U2 via the VR device 14 may be referred to as the main or primary version (as the second user is the primary consumer of the content), whereas the version of the VR content provided to the first user U1 may be referred to as a secondary version.

In examples in which the system 1 includes the second portable UE 14, the second location L2 may be defined by a geographic location of the second UE 14. In such examples, the orientation O2 of the content may be fixed or may be dependent on a current orientation of the second user U2 within the VR world.

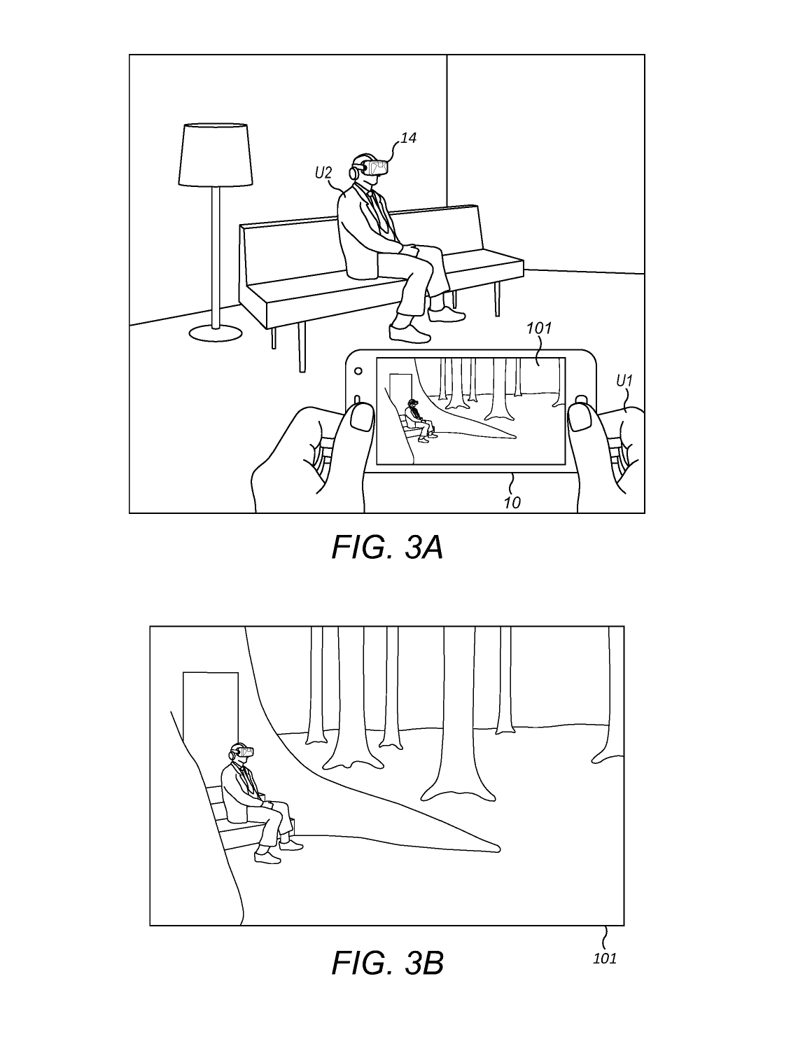

The first portable UE 10 and/or the computer server apparatus 12 may be configured to cause the first UE 10 to capture visual content from a field of view FOV associated with the first orientation O1. The field of view may be defined by the first orientation and a range of angles F. When the first UE 10 is oriented towards the second UE 14 and the second UE 14 is worn by the second user U2, the first user U2 may be provided with captured visual content representing the second user U2 in conjunction with the first version of the virtual reality content. This scenario is illustrated in FIG. 3A in which the second user U2 is using their VR device 14 in their living room and the first user U2 is observing the second user's VR experience via the first UE 10.

FIG. 3B shows an enlarged view of the display 101 of the first UE 10 via which the first version of the VR content is being provided to the first user U1. As the first UE 10 is, in this example, operating as an augmented reality device, the display 101 shows the second user U2 within the VR world.

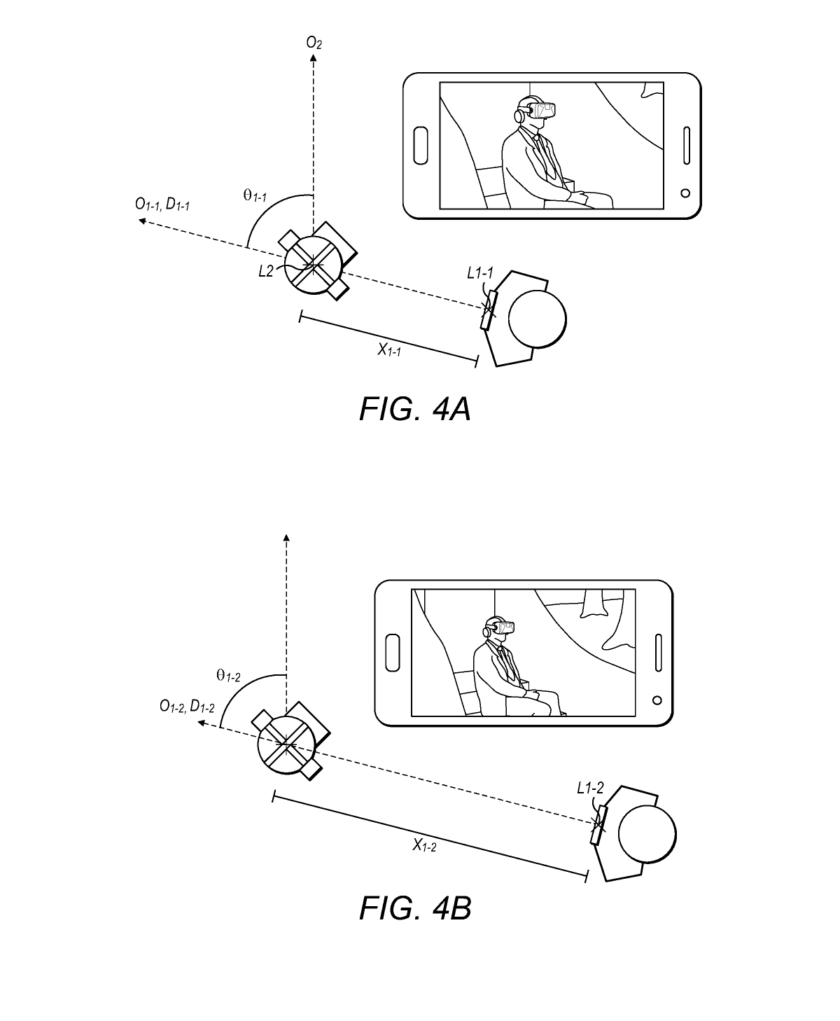

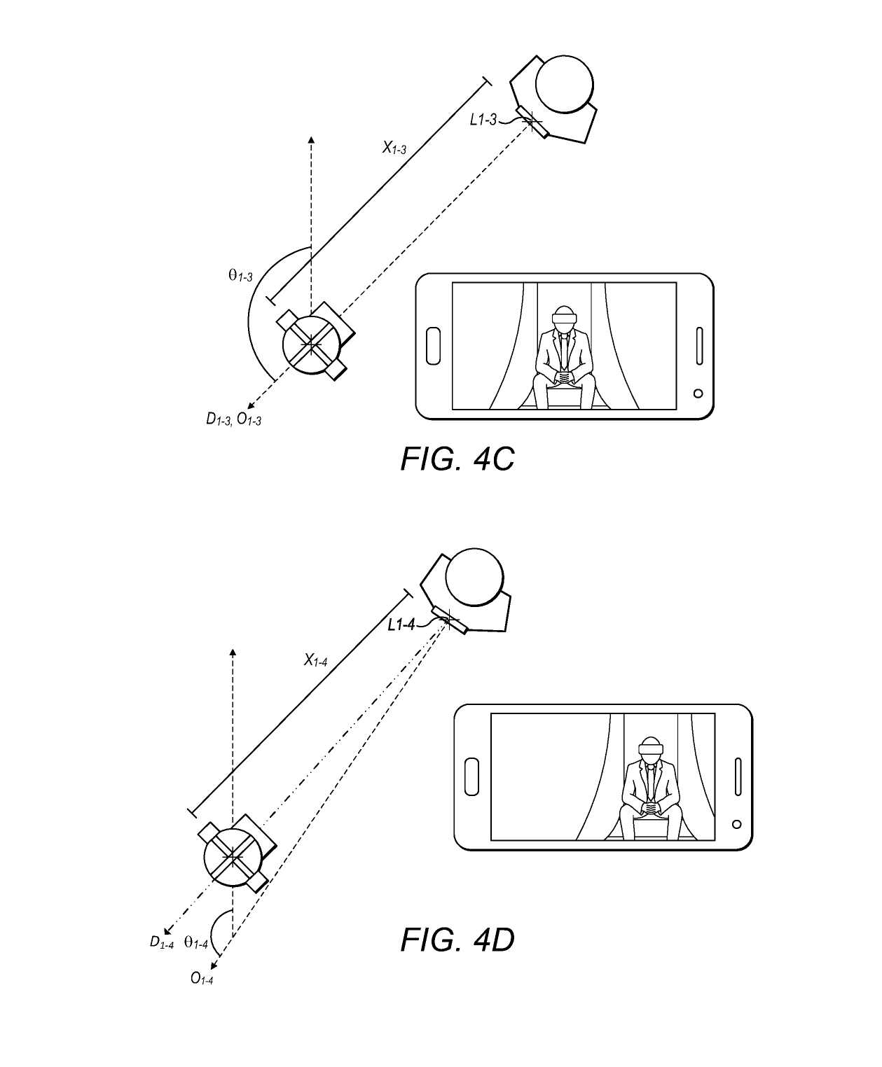

FIGS. 4A to 4D show various different locations L1 and the orientations O1 of the first UE 10 relative to the second location L2 and second orientation O2 of associated with the VR content. The figures also show the first version of the VR content that is rendered for the first user U1 on the basis of those locations and orientations. FIGS. 4A to 4B, therefore, illustrate the relationship between the first version of visual VR content provided to the first user U1 and the first location L1 and orientation O1 of the first UE 10 relative to the location L2 and orientation O2 associated with the VR content.

In FIG. 4A, the first UE is at a first location L1-1 and is oriented with an orientation O1-1. The difference between the orientation O1-1 of the first UE and the orientation O2 associated with the VR content is θ1-1. The direction from the first location L1-2 to the second location L2 is D1-1 and the distance between the first and second locations is X1-1.

In FIG. 4B, the first UE 10 has moved directly away from the second location L2 to a location L1-2. As the first UE 10 has moved directly away from the second location L2, the difference between the orientation O1-2 of the first UE 10 and that associated with the VR content O2 remains the same (i.e. θ1-2=θ1-1). The direction from the new location L1-2 of the first UE 10 to the second location L2 also remains the same (i.e. D1-2=D1-1). However, the distance X1-2 between the location of the first UE L1-2 and the location associated with the VR content L2 is now greater than in FIG. 4A (i.e. X1-2>X1-1). This is reflected by the first version of the VR content being displayed with a lower magnification and so as to appear further away from the first user U2.

In FIG. 4C, the first UE 10 has moved around the second location L2 to a location L1-3 but the distance between the first UE 10 and the second location L2 remains the same (i.e. X1-2=X1-3). Due to the movement of the first UE 10 around the second location L2, the direction D1-3 from the first UE 10 to the second location L2 has changed. In addition, although the orientation O1-3 of the first UE remains directly towards the second location L2, the change in direction results in a change in relative orientation. Put another way, the difference θ1-3 between the orientation O1-3 of the first UE and that associated with the VR content O2 has changed. This change in relative orientation is reflected in a different portion of the visual VR content being the provided. However, as the distance X1-3 between the first UE 10 and the second location remains the same, the magnification with which the visual VR content is displayed also remains the same.

Finally, in FIG. 4D, the first UE 10 has remained in the same location but the first UE has been rotated slightly away from the second location. As such, the distance between the first UE 10 and the second location L2 remains the same (i.e. X1-3=X1-4) and the direction from the first UE 10 to the second location L2 remains the same (i.e. D1-4=D1-3). However, due to the rotation of the first UE 10, the difference in orientation θ1-4 has changed. This is reflected by a slightly rotated view of the VR content being displayed to the first user.

Although the principles have been explained above using a scenario in which the system 1 includes the second device 14, in other examples, the second device 14 may not be present. Instead, the virtual reality content may be associated with a fixed geographic location and fixed orientation. For instance, the VR content may be associated with a particular geographic location of interest and the first user may be able to use the first UE 10 to view the VR content. The geographic location of interest may be, for instance, an historical site and the VR content may be immersive visual content (either still or video) which shows historical figures within the historical site. In examples in which the first UE 10 is an augmented reality device, the VR content may include only the content representing the historical figures and the device 10 may merge this content with real time images of the historic site as captured by the camera of the first UE 10. Examples of the system 1 described herein may thus be utilised for provision of touristic content to the first user. For instance, the first user U1 may arrive at a historic site with which some VR content is associated and may use their portable device 10 to view to VR content from different directions depending on their location relative to the historic site and the orientation of their device. In other examples, the content may be a virtual reality advertisement.

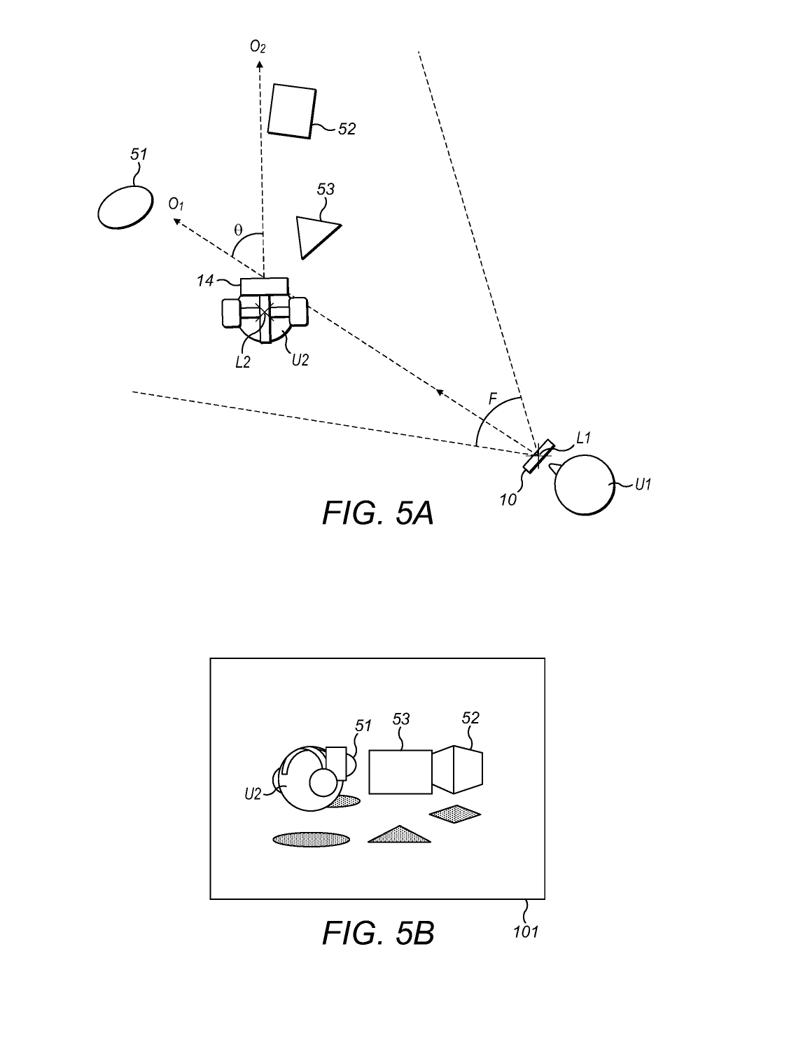

In some examples, e.g. in which the VR content is computer-generated, the different views of the VR content may already be available. As such, rendering these views on the basis of the first location relative to the second location and the first orientation relative to the second orientation may be relatively straightforward. This is illustrated in FIGS. 5A and 5B.

FIG. 5A shows the virtual positions of various objects 51, 52, 53 in the VR world relative to the second location L2 (which, in this example, is the location of the second user U2 who is immersed in the virtual reality content) and the first location L1 of the first UE 10. FIG. 5B shows the first version of the VR content (including the objects 51, 52, 53) that is displayed to the user via the display 101 of the first UE 10.

As mentioned above, the viewpoint from which the first user is viewing the VR content may, in some examples, already be available and as such the generation of the first version of the VR content may be relatively straightforward.

However, in other examples, for instance when the VR content has been captured by a presence capture device, the VR content may be available only from a certain viewpoint (i.e. the viewpoint of the presence capture device). In such examples, some pre-processing of the VR content may be performed prior to rendering the first version of the VR content for display to the first user U1.

A presence capture device may be a device comprising an array of content capture modules for capturing audio and/or video content from various different directions. For instance, the presence capture device may include a 2D (e.g. circular) array of content capture modules for capturing visual and/or audio content from a wide range of angles (e.g. 360-degrees) in a single plane. The circular array may be part of a 3D (e.g. spherical or partly spherical) array for capturing visual and/or audio content from a wide range of angles in plural different planes.

FIG. 10 is a schematic illustration of a presence capture device 95 (such as Nokia's OZO), which includes a spherical array of video capture modules 951 to 958. Although not visible in the Figure, the presence capture device may further comprise plural audio capture modules (e.g. directional microphones) for capturing audio from various directions around the device 95. It should be noted that the device 95 may include additional video/audio capture modules which are not visible from the perspective of FIG. 10. The device 95 may therefore capture content derived from all directions.

The output of such devices is plural streams of visual (e.g. video) content and/or plural streams of audio content. These may be combined so as to provide VR content for consumption by a user. However, as mentioned above, the content allows for only one viewpoint for the VR content, which is the viewpoint corresponding to the location of the presence capture device during capture of the VR content.

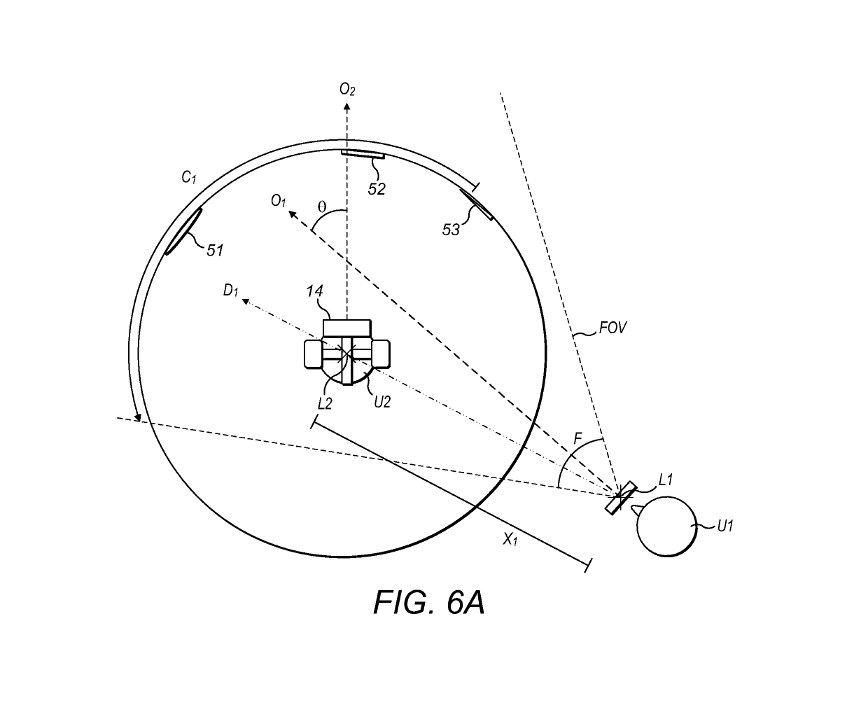

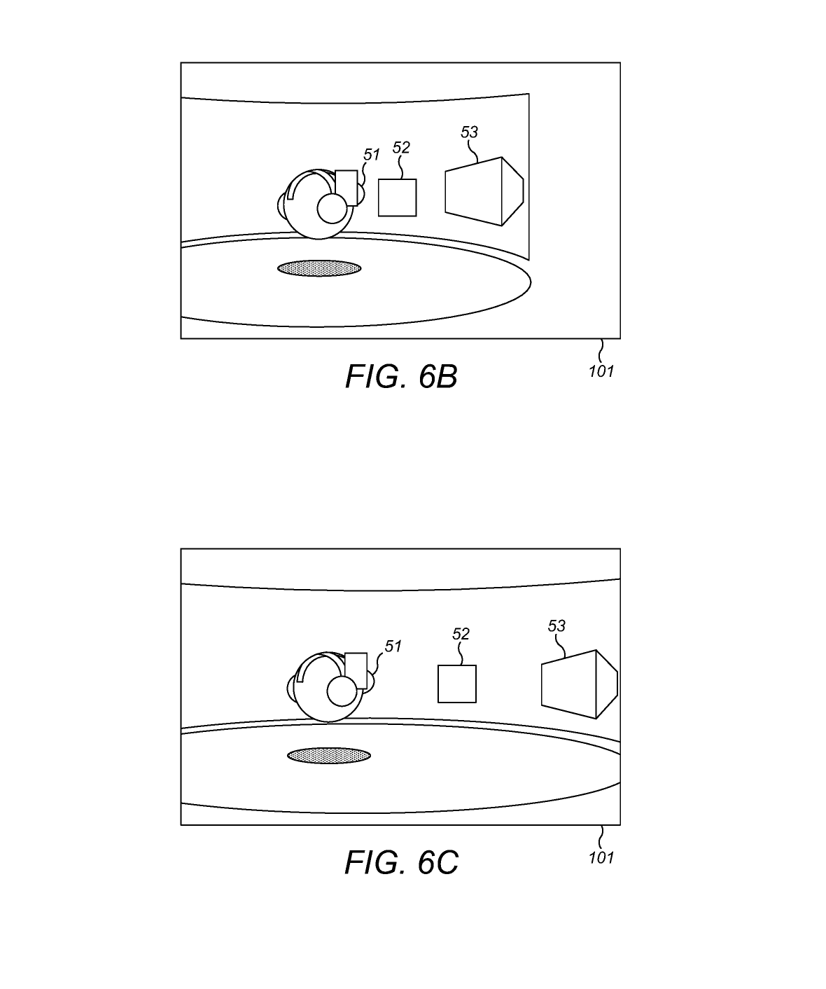

In order to address this, some pre-processing is performed in respect of the VR content. More specifically, with regard to the visual component of the VR content, a panorama is created by stitching together the plural streams of visual content. If the content is captured by a presence capture device which is configured to capture content in more than one plane, the creation of the panorama may include cropping upper and lower portions full content. Subsequently, the panorama is digitally wrapped around the second location L2, to form a cylinder (hereafter, referred to as “the VR content cylinder”), with the panorama being on the interior surface of the VR content cylinder. The VR content cylinder is centred on L2 and has a radius R associated with it. The radius R may be a fixed pre-determined value or a user-defined value. Alternatively, the radius may depend on the distance between L1 and L2 and the viewing angle (FOV) of the first UE 10 such that the content cylinder 60 is always visible in full via the first UE. An example of the VR content cylinder 60 is illustrated in FIG. 6A and shows the locations of the visual representations of the first, second and third objects 51, 52, 53 within the panorama.

Although the creation of the content cylinder is described with reference to plural video streams, it may in some examples be created on the basis of plural still images each captured by a different camera module. The still images and video streams may be collectively referred to as “visual content items”.

The VR content cylinder 60 is then used to render the first version of the VR content for provision to the first user of the first UE 10. More specifically, a portion of the VR content cylinder is provided to the user in dependence on the location of the first UE 10 relative to the second location L2 and the orientation O1 of the first UE O1 relative to the orientation O2 of the content VR content cylinder 60.

The portion may additionally be determined in dependence on the field of view of the first UE 10. Where the first UE is operating as an augmented reality device, the field of view may be defined by the field of view of the camera 108 of the device 10 and may comprise a range of angles F which is currently being imaged by the camera module 108 (this may depend on, for instance, a magnification level currently being employed by the camera module. In examples in which the first UE 10 is not operating as an augmented reality device, the field of view may be pre-defined range of angles centred on a normal to, for instance, a central part of the reverse side of the display 101.

The portion of the VR content cylinder 60 for provision to the user may thus be determined on the basis of ranges of angles F associated with the field of view (FoV), the location of the first UE L1 relative to the second location L2, the distance X1 between the location L1 of the first UE 10 and the second location L2, and the orientation of the first UE 10 relative to the orientation of the content cylinder O2 (defined by angle θ). Based on these parameters, it is determined which portion of the content cylinder 60 is currently within the field of view of the first UE 10. In addition, it is determined, based on the location L1 of the first UE 10 relative to the second location L2 and the orientation of the first UE 10 relative to the orientation O2 of the content cylinder, which portion of the panorama is facing generally towards first UE 10 (i.e. the normal to which is at an angle to the orientation of the first UE which has a magnitude of less than 90 degrees).

The first version of the VR content which is provided for display to the first user may comprise only a portion of the panorama which is both within the field of view of the first UE and which is facing generally towards the first UE. This portion of the panorama may be referred to as the “identified portion”. The identified portion of the panorama can be seen displayed in FIG. 6B, and is indicated by reference C_{I}.

As can be seen in FIG. 6B, in some examples, the identified portion C_{I} of the panorama may not be, at a default magnification, large enough to the fill the display 101. As such, in some examples, the portion may be re-sized such that the identified portion is sufficiently large enough to fill at least the width of the display screen 101. This may be performed by enlarging the radius of the content cylinder as is illustrated in FIG. 6C. In other examples, this may be performed by simply magnifying the identified portion of the VR content. In such examples, the magnification may be such that the width and/or the height of the display is filled by the identified content.

In some examples in which the location L1 of the first UE 10 is less than the radius R from the second location L2 (or, put another way, the first UE is within the content cylinder) the range of angles defining the field of view may be enlarged, thereby to cause a larger portion of the panorama to be displayed to the first user.

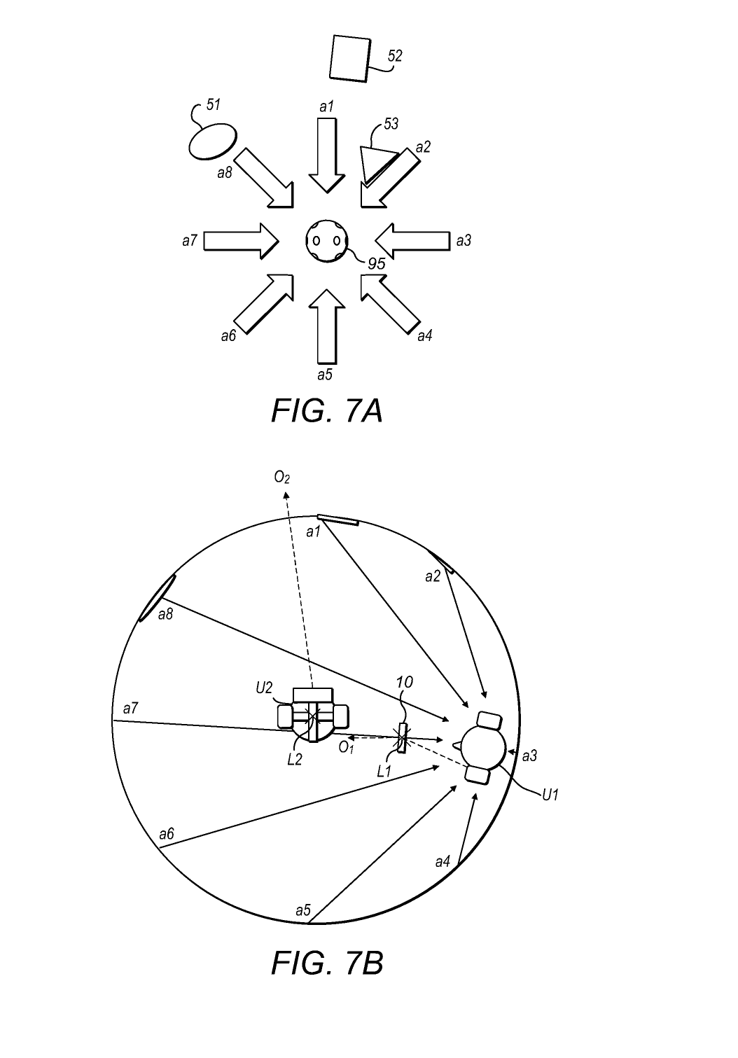

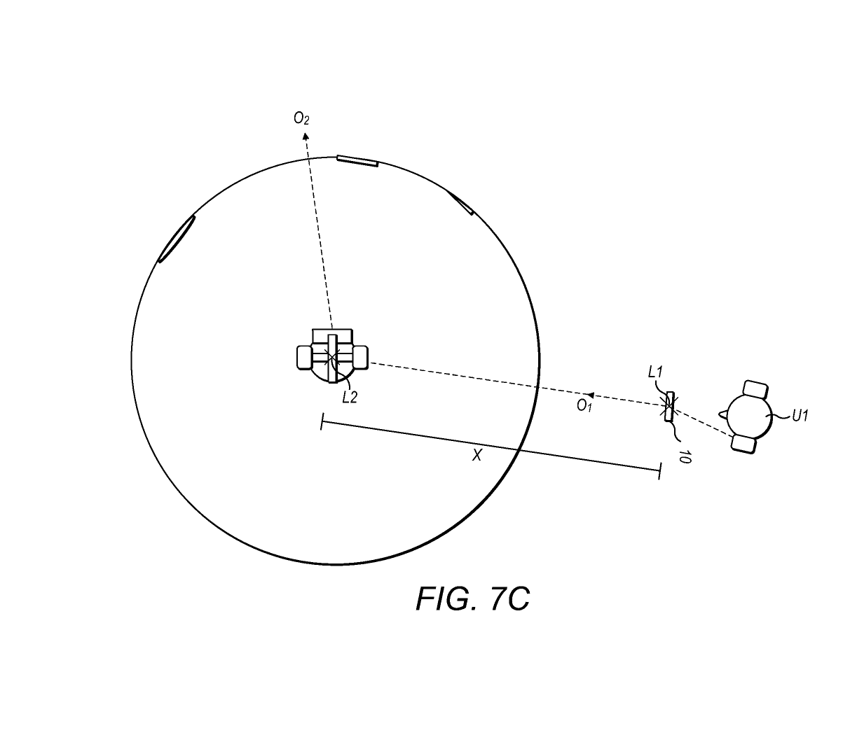

Many of the above-described principles apply similarly to audio components of VR content as to visual components. The audio component of the VR content may include plural sub-components each of which are associated with a different direction surrounding the location L2 associated with the VR content. For instance, these sub components may each have been captured using a presence capture device 95 comprising plural directional microphones each oriented in a different direction. Alternatively or in addition, these sub components may have been captured with microphones external to the presence capture device 95, with each microphone being associated with location data. Thus, in this case a sound source captured by an external microphone is considered to reside at a location of the external microphone. An example of an external microphone is a head-worn Lavalier microphone for speakers and singers or a microphone for a musical instrument such as an electric guitar. FIG. 7A illustrates the capture of audio content from a scene, in which the audio content comprises eight sub-components al to a8 each captured from a different direction surrounding the capture device 95.

As with the visual content, audio VR content may be provided to the first user in dependence on both the location L1 of the first UE 10 relative to the second location L2 and the orientation O1 of the first UE 10 relative to the orientation O2 associated with the VR content. An example of this is illustrated in and described with reference to FIGS. 7B and 7C. The audio component of the VR content may be provided to the user using binaural rendering. As such, the first UE 10 may be coupled with an audio output device 11 which is capable of providing binaurally-rendered audio to the first user. Furthermore, head-tracking using an orientation sensor may be applied to maintain the sound field at a static orientation while the user rotates his head. This may be performed in a similar manner as for the visual content.

In FIG. 7B, the first UE 10 is within a predetermined distance from the second location L2. In examples in which the VR content also comprises a visual component, this pre-determined threshold may correspond to the radius R of the VR content cylinder.

When the first UE 10 is within the predetermined distance from the second location L2, the audio component may be provided to the user of the first UE 10 using a binaurally-capable audio output device 11 such that the sub-components appear to originate from different directions around the first user. Put another way, each of the sub-components may be provided in such a way that they appear to derive from a different location on a circle having the predetermined distance as it radius and location L2 as its centre. In examples in which a VR content cylinder of visual content is generated, each sub-component may be mapped to a different location on the surface of the content cylinder.

The relative directions of the sub-components are dependent on both the location L1 of the first UE 10 relative to the second location L2 and also the orientation O1 of the first UE 10 relative to the second orientation O2. For instance, in the example of FIG. 7B, due to the orientation O1 and location L1 of the first UE 10, the sub-component a3 is rendered so as to appear originate from behind the first user and sub-component a7 is rendered to so as to appear to originate from directly in front of the first user. However, if the first UE 10 were to be rotated by 90 degrees in the clockwise direction, sub-component a3 would appear to originate from the right of the user U1 and sub-component a7 would appear to originate from the left of the user.

A gain applied to each of the sub-components may be dependent on the distance from the location L1 of the first UE 10 to the location on the circle/cylinder with which the sub-component is associated. Furthermore, in some example methods for binaural rendering, the relative degree of direct sound to indirect (ambient or “wet” sound) may be dependent on the distance, so that the degree of direct sound is increased when the distance is decreased and vice versa.

In FIG. 7C, the first UE 10 is outside the predetermined distance from the second location L2. In this situation, the virtual reality audio content may be provided to the user in such a way that it appears to originate from a single point source. The location of the single point source may be, for instance, the second location L2. In some examples, a gain of each of the different sub-components which constitute the virtual reality audio content may be determined based on the distance between the location L1 of the first UE 10 and the locations around the circle with which each sub-component is associated. As such, in the example of FIG. 7C, the sub-component a3 may have a larger gain than does sub-component a7. Correspondingly, also the ratio of direct sound to indirect sound can be controlled based on the distance.

When the user is outside the predetermined distance, the virtual reality audio component may be rendered depending on the orientation of the first UE. As such, in the example of FIG. 7C, the audio component may be provided such that it appears to originate from directly in front of the user (as the orientation O1 of the first UE is directly towards the second location L2). However, if the first UE 10 were to be rotated 90 degrees clockwise, the audio component would be provided such that it appears to arrive from the left of the first user U1.

Although not visible in FIGS. 7B and 7C, the first UE 10 (or the server apparatus 12) may be configured such that, when the first UE is within the predetermined distance from the second location L2, the first UE may cause provision of active noise control (ANC) to cancel out exterior sounds. For example, when the first UE 10 is within the predetermined distance, the ANC may be fully enabled (i.e. a maximum amount of ANC may be provided). In this way, the first user can become “immersed” in the VR content when they approach within a particular distance of the location L2. When the first UE 10 is outside the predetermined distance, ANC may be disabled or may be partially enabled in dependence on the distance from the second location L2. Where ANC is partially enabled, there may be an inverse relationship between the distance and the amount of ANC applied. As such, at distance D_{T} (or less) from L2, a maximum amount of ANC may be applied, with the amount of ANC decreasing as the first UE 10 moves further beyond the distance D_{T} from L2.

Although the techniques for provision of audio VR content as described with reference to FIGS. 7B and 7C have been explained primarily on the basis of audio captured using a presence capture device, the techniques are equally applicable to computer-generated audio VR content.

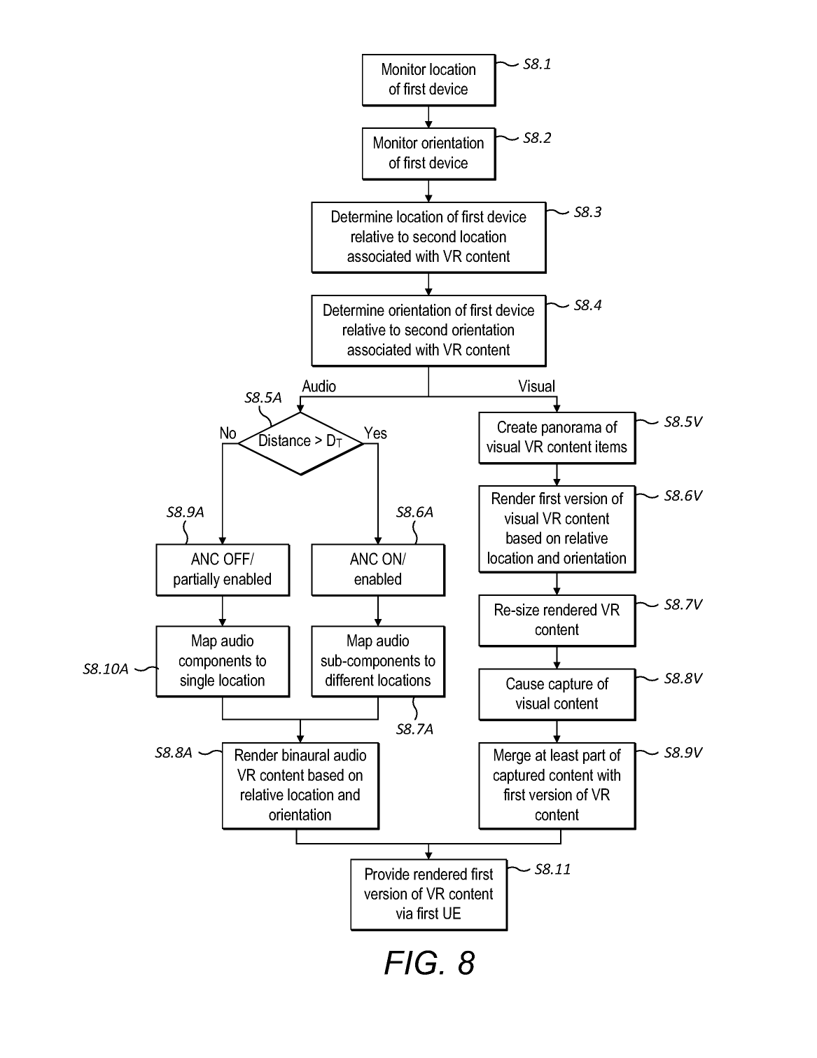

As will be appreciated, the VR audio content provided as described with reference to FIGS. 7A to 7C may be provided in addition to visual content. FIG. 8 is a flow chart illustrating a method which may be performed by the first UE 10 (optionally in conjunction with the server apparatus 12) to provide VR content including both audio and visual components to the user of the first UE 10. However, it will of course be understood that, in examples in which the VR content contains only a visual component, the operations associated with provision of the audio components may be omitted. Similarly, in examples in which the VR content contains only an audio component, the operations associated with the visual components may be omitted.

In operation S8.1, the location L1 of the first UE 10 is monitored. The location may be determined in any suitable way. For instance, GNSS (e.g. when the first UE 10 is outdoors) or a positioning method based on transmission or receipt by the first UE 10 of radio frequency (RF) packets may be used.

In operation S8.2, the orientation O1 of the first UE 10 is monitored. This may also be determined in any suitable way. For instance, the orientation may be determined using one or more sensors 105 (see FIG. 9A) such as gyroscopes, accelerometers and magnetometers. In examples in which the first UE 10 comprises a head-mounted augmented reality device, the orientation may be determined, for instance, using a head-tracking device.

In operation S8.3, the orientation O1 of the first UE 10 relative to the orientation O2 associated with the VR content is determined. This may be referred to as the “relative orientation” and may be in the form of an angle between the orientations (i.e. a difference between the two orientations). Where the orientation O2 associated with the VR content is variable (e.g. it is based on an orientation of the user in the VR world), the orientation O2 may be continuously monitored such that a current orientation O2 is used at all times.

In operation S8.4, the location L1 of the first UE 10 relative to the location L2 associated with the VR content may be determined. This may be referred to as the “relative location” and may be in the form of a direction (from the second location to the first location or vice versa) and a distance between the two locations. As mentioned above, the location L2 associated with the location of the VR content may be a location of the VR device 14 for providing VR content to the second user. In such examples, location of the second device L2 may be continuously provided for use by the first UE 10 and/or the server apparatus 12.

After operation S8.4, the method splits into two branches, one for audio components of the VR content and one for visual components of the VR content. Where the VR content comprises both visual and audio components, the two branches may be performed simultaneously.

In the visual content branch, operation S8.5V may be performed in which the cylindrical panorama of the different items of visual content is created (as described with reference to FIGS. 6A to 6C). This operation may be omitted if the panorama has previously been created. Similarly, if the visual content is computer generated 3D content, operation S8.5V may not be required.

Subsequently, in operation S8.6V, the first version of the visual VR content is rendered based on the relative location of the first UE and the relative orientation of the first UE. As mentioned above, the first version may be rendered also in dependence on the angle F associated with the field of view of the first UE 10. In examples, in which the visual VR content is computer-generated navigable 3D content currently being experienced by a user of a VR device 14, the rendering of the first version of the VR content may also be dependent on a current location and orientation of the second user within the visual VR content.

In operation S8.7V, the first version of the visual VR content may be re-sized in dependence on display parameters (e.g. width and/or height) associated with the display 101 of the first UE 10. The rendered VR content may thus be re-sized to fill at least the width of the display 101. As will be appreciated, this operation may, in some examples, be omitted.

If the first UE 10 is operating as an augmented reality device, operation S8.8V may be performed in which content is caused to be captured by the camera module 108 of the UE 10. Next, in operation S8.9V, at least part of the captured content (e.g. that representing the second user) is merged with rendered first version of the VR content.

Moving now to the audio branch, in operation S8.5A, it is determined (from the relative location of the first UE) if the distance between the first UE and the location L2 associated with the VR content is above a threshold distance D_{T}. Put another way, operation S8.5A may comprise determining whether the first UE 10 is within the content cylinder.

If it is determined that the distance is below the threshold, operation S8.6A is performed in which the ANC is enabled (or fully enabled), thereby to cancel out exterior noise.

Subsequently, in operation S8.7A, the various audio sub-components are mapped to various locations around the content cylinder. After this, in operation S8.8A, the sub-components are binaurally rendered in dependence on the relative location and orientation of the first UE 10.

If, in operation S8.5A, it is determined that the distance is above the threshold, the first UE disables, or only partially enables, the ANC in operation S8.9A. The level at which ANC is partially enabled may depend on the distance between the first and second locations.

Next, in operation S8.10A, the audio sub-components are all mapped to a single location (e.g. the location L2 associated with the VR content). After this, in operation S8.8A, the sub-components are binaurally rendered in dependence on the relative location and orientation of the first UE 10.

In operation S8.11A, the rendered audio content and/or visual content is provided to the user via the first UE. After this, the method returns to operation S8.1.

The operations depicted in FIG. 8 may be performed by different parts of the system illustrated in FIG. 1. For instance, in some non-limiting examples, operations S8.1 to S8.4 may be performed by the first UE 10, operations S8.5V to S8.9V may be performed by the first UE 10 or the server apparatus 12 depending on the type of visual data (although typically these operations may be performed by the server), operations S8.9A and S8.8A may be performed by the UE 10, operations S8.6A, S8.7A and S8.10A may be performed by the UE 10 or the server 12 depending on the nature of the audio data received from the server 12 (although typically they are performed by the UE 10) and operation S8.11 may be performed by the UE. In order to share the operations between the first UE 10 and the server apparatus 12, it will be appreciated that the data necessary for performing each of the operations may be communicated between the first UE 10 and server 12 as required.

Although not shown in the Figures, in some examples, the second user may be provided with a visual representation of the first user. In such examples, the second UE 14 may be controlled to provide a visual representation of the first user within the second version of the VR content currently being experienced by the second user. The visual representation of the first user may be provided in dependence on the location and orientation of the first UE (e.g. as a head at the location of the first UE and facing in the direction of orientation of the first UE). As such, the server apparatus 12 may continuously monitor (or be provided with) the location and orientation of the first UE 10. This may facilitate interaction with the second user who is currently immersed in the VR world.

It may also be possible for the user U1 of the first UE 10 to interact with visual VR content. For instance, the user may be able to provide inputs via the first UE 10 which cause an effect in the VR content. For instance, where the VR content is part of a computer game, the user of the first UE 10 may be able to provide inputs for fighting enemies or manipulating objects. By orienting the first UE 10 in a different direction, the first user is presented with a different part of the visual content with which to interact. Moreover by moving in a particular direction, it may be possible to view the visual content more closely. Other examples of interaction include the viewing of content items which are represented at a particular location within the VR content, organizing files, and so on.

In examples in which the first user U1 does interact with the VR content, this interaction may be reflected in the content provided to the second user U2. For instance, the second user U2 may be provided with sounds and or changes in the visual content which result from interaction by the first user U1.

FIGS. 9A and 9B are schematic block diagrams illustrating example configurations of the first UE 10 and the server apparatus 12.

As can be seen in FIG. 9A, the first UE 10 comprises a controller 100 for controlling the other components of the UE. In addition, the controller 100 may cause performance of at least part of the functionality described above with regards provision of VR content to the first user U1. For instance, in some examples each of operations S8.1 to S8.11 may be performed by the first UE 10 based on VR content received from the server apparatus 12. In other examples, the first UE 10 may only be responsible for operation S8.11 with the other operations being performed by the server apparatus 12. In yet other examples, the operations may be split between the first UE 10 and the server apparatus 12 in some other way.

The first UE 10 may further comprise a display 101 for providing visual VR content to the user U2.

The first UE 10 may further comprise an audio output interface 102 for outputting VR audio (e.g. binaurally rendered VR audio) to the user U1. The audio output interface 102 may comprise a socket for connecting with the audio output device 11 (e.g. binaurally-capable headphones or earphones).

The first UE 10 may further comprise a positioning module 103 comprising components for enabling determination of the location L1 of the first device 10. This may comprise, for instance, a GPS module or, in other examples, an antenna array, a switch, a transceiver and an angle-of-arrival estimator, which may together enable to the first UE 1 to determine its location based on received RF packets.

The first UE 10 may further comprise one or more sensors 104 for enabling determination of the orientation O1 of the first UE 10. As mentioned previously, these may include one or more of an accelerometer, a gyroscope and a magnetometer. Where the UE includes a head-mounted display, the sensors may be part of a head-tracking device.

The first UE 10 may include one or more transceivers 105 and associated antennas 106 for enabling wireless communication (e.g. via Wi-Fi or Bluetooth) with the server apparatus 12. Where the first UE 10 comprises more than one separate device (e.g. a head-mounted augmented reality device and a mobile phone), the first UE may additionally include a transceivers and antennas for enabling communication between the constituent devices.

The first UE may further include a user input interface 107 (which may be of any suitable sort e.g. a touch-sensitive panel forming part of a touch-screen) for enabling the user to provide inputs to the first UE 10.

As discussed previously, the first UE 100 may include a camera module 108 for capturing visual content which can be merged with the VR content to produce augmented VR content.

As shown in FIG. 9B, the server apparatus 12 comprises a controller 120 for providing any of the above-described functionality that is assigned to the server apparatus 12. For instance, the controller 120 may be configured to provide the VR content (either rendered or in raw form) for provision to the first user U1 via the first UE 10. The VR content may be provided to the first UE 10 via a wireless interface (comprising a transceiver 121 and antenna 122) operating in accordance with any suitable protocol.

The server apparatus 12 may further include an interface for providing VR content to the second UE 14, which may be for instance a virtual reality headset. The interface may be wired or wireless interface for communicating using any suitable protocol.

As mentioned previously, the server apparatus 12 may be referred to as a VR content server apparatus and may be for instance, a games console or a LAN or cloud-based server computer 12 or a combination of various different local and and/or remote server apparatuses.

As will be appreciated, the location L1 (and, where applicable, L2) described herein may refer to the locations of a UE or may, in other examples refer to the locations of the user of the UE.

Some further details of components and features of the above-described UEs and apparatuses 10, 12 and alternatives for them will now be described, primarily with reference to FIGS. 9A and 9B.

The controllers 100, 120 of each of the UE/apparatuses 10, 12 comprise processing circuitry 1001, 1201 communicatively coupled with memory 1002, 1202. The memory 1002, 1202 has computer readable instructions 1002A, 1202A stored thereon, which when executed by the processing circuitry 1001, 1201 causes the processing circuitry 1001, 1201 to cause performance of various ones of the operations described with reference to FIGS. 1 to 9B. The controllers 100, 120 may in some instances be referred to, in general terms, as “apparatus”.

The processing circuitry 1001, 1201 of any of the UE/apparatuses 10, 12 described with reference to FIGS. 1 to 9B may be of any suitable composition and may include one or more processors 1001A, 1201A of any suitable type or suitable combination of types. For example, the processing circuitry 1001, 1201 may be a programmable processor that interprets computer program instructions 1002A, 1202A and processes data. The processing circuitry 1001, 1201 may include plural programmable processors. Alternatively, the processing circuitry 1001, 1201 may be, for example, programmable hardware with embedded firmware. The processing circuitry 1001, 1201 may be termed processing means. The processing circuitry 1001, 1201 may alternatively or additionally include one or more Application Specific Integrated Circuits (ASICs). In some instances, processing circuitry 1001, 1201 may be referred to as computing apparatus.

The processing circuitry 1001, 1201 is coupled to the respective memory (or one or more storage devices) 1002, 1202 and is operable to read/write data to/from the memory 1002, 1202. The memory 1002, 1202 may comprise a single memory unit or a plurality of memory units, upon which the computer readable instructions (or code) 1002A, 1202A is stored. For example, the memory 1002, 1202 may comprise both volatile memory 1002-2, 1202-2 and non-volatile memory 1002-1, 1202-1. For example, the computer readable instructions 1002A, 1202A may be stored in the non-volatile memory 1002-1, 1202-1 and may be executed by the processing circuitry 1001, 1201 using the volatile memory 1002-2, 1202-2 for temporary storage of data or data and instructions. Examples of volatile memory include RAM, DRAM, and SDRAM etc. Examples of non-volatile memory include ROM, PROM, EEPROM, flash memory, optical storage, magnetic storage, etc. The memories in general may be referred to as non-transitory computer readable memory media.

The term ‘memory’, in addition to covering memory comprising both non-volatile memory and volatile memory, may also cover one or more volatile memories only, one or more non-volatile memories only, or one or more volatile memories and one or more non-volatile memories.

The computer readable instructions 1002A, 1202A may be pre-programmed into the apparatuses 10, 12. Alternatively, the computer readable instructions 1002A, 1202A may arrive at the apparatus 10, 12 via an electromagnetic carrier signal or may be copied from a physical entity 90 (see FIG. 9C) such as a computer program product, a memory device or a record medium such as a CD-ROM or DVD. The computer readable instructions 1002A, 1202A may provide the logic and routines that enables the UEs/apparatuses 10, 12 to perform the functionality described above. The combination of computer-readable instructions stored on memory (of any of the types described above) may be referred to as a computer program product.

Where applicable, wireless communication capability of the apparatuses 10, 12 may be provided by a single integrated circuit. It may alternatively be provided by a set of integrated circuits (i.e. a chipset). The wireless communication capability may alternatively be a hardwired, application-specific integrated circuit (ASIC).

As will be appreciated, the apparatuses 10, 12 described herein may include various hardware components which may not have been shown in the Figures. For instance, the first UE 10 may in some implementations include a portable computing device such as a mobile telephone or a tablet computer and so may contain components commonly included in a device of the specific type. Similarly, the apparatuses 10, 12 may comprise further optional software components which are not described in this specification since they may not have direct interaction to embodiments of the invention.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

As used in this application, the term ‘circuitry’ refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

If desired, the different functions discussed herein may be performed in a different order and/or concurrently with each other. Furthermore, if desired, one or more of the above-described functions may be optional or may be combined. Similarly, it will also be appreciated that flow diagram of FIG. 8 is an example only and that various operations depicted therein may be omitted, reordered and or combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. A method comprising:
causing provision of a first version of virtual reality content to a first user via first portable user equipment located at a first location and having a first orientation, the virtual reality content being associated with a second location and a second orientation, the first version of the virtual reality content being rendered for provision via the first user equipment in dependence on the first location relative to the second location and the first orientation relative to the second orientation.

2. A method according to claim 1, wherein the virtual reality content is derived from plural content items each derived from a different one of plural content capture devices arranged in a two-dimensional or three-dimensional array and wherein the first version of the virtual reality content comprises a portion of a cylindrical panorama created using visual content of the plural content items, the portion of the cylindrical panorama being dependent on the first location relative to the second location and the first orientation relative to the second orientation.

3. A method according to claim 1, wherein the virtual reality content comprises audio content comprising plural audio sub-components each associated with a different location around the second location, wherein the method further comprises:
when it is determined that the distance between the first and second locations is above a threshold, causing provision of the audio sub-components to the user via the first user equipment such that they appear to originate from a single point source.

4. A method according to claim 1, wherein the virtual reality content comprises audio content comprising plural audio sub-components each associated with a different location around the second location, wherein the method further comprises:
when it is determined that the distance between the first and second locations is below a threshold, causing provision of the virtual reality audio content to the user via the first user equipment such that sub-components of the virtual reality audio content appear to originate from different directions around the first user.

5. A method according to claim 1, wherein the virtual reality content comprises audio content and wherein the method further comprises:
when it is determined that the distance between the first and second locations is below a threshold, causing noise cancellation to be provided in respect of sounds other than the virtual reality audio content.

6. A method according to claim 1, wherein the virtual reality content comprises audio content and wherein the method further comprises:
when it is determined that the distance between the first and second locations is above a threshold, setting a noise cancellation level in dependence on the distance between the first and second locations, such that a lower proportion of external noise is cancelled when the distance is greater than when the distance is less.

7. Apparatus comprising:
at least one processor; and
at least one memory including computer program code, which when executed by the at least one processor, causes the apparatus: to cause provision of a first version of virtual reality content to a first user via first portable user equipment located at a first location and having a first orientation, the virtual reality content being associated with a second location and a second orientation, the first version of the virtual reality content being rendered for provision via the first user equipment in dependence on the first location relative to the second location and the first orientation relative to the second orientation.

8. Apparatus according to claim 7, wherein the second location is defined by a location of second portable user equipment for providing a second version of the virtual reality content to a second user.

9. Apparatus according to claim 8, wherein the computer program code, when executed by the at least one processor, causes the apparatus to cause the first portable user equipment to capture visual content from a field of view associated with the first orientation and, when the first user equipment is oriented towards the second user equipment worn by the second user, to cause provision to the user of captured visual content representing the second user in conjunction with the first version of the virtual reality content.

10. Apparatus according to claim 7, wherein the virtual reality content is associated with a fixed geographic location and orientation.

11. Apparatus according to claim 7, wherein the virtual reality content is derived from plural content items each derived from a different one of plural content capture devices arranged in a two-dimensional or three-dimensional array.

12. Apparatus according to claim 11, wherein the first version of the virtual reality content comprises a portion of a cylindrical panorama created using visual content of the plural content items, the portion of the cylindrical panorama being dependent on the first location relative to the second location and the first orientation relative to the second orientation.

13. Apparatus according to claim 12, wherein the portion of the cylindrical panorama is dependent on a field of view associated with the first user equipment.

14. Apparatus according to claim 12, wherein the portion of the cylindrical panorama which is provided to the first user via the first user equipment is sized such that it fills at least one of a width and a height of a display of the first user equipment.

15. Apparatus according to claim 7, wherein the first version of the virtual reality content is provided in combination with content captured by a camera module of the first user equipment.

16. Apparatus according to claim 7, wherein the virtual reality content comprises audio content comprising plural audio sub-components each associated with a different location around the second location, wherein the computer program code, when executed by the at least one processor, causes the apparatus:
when it is determined that the distance between the first and second locations is above a threshold, to cause provision of the audio sub-components to the user via the first user equipment such that they appear to originate from a single point source.

17. Apparatus according to claim 7, wherein the virtual reality content comprises audio content comprising plural audio sub-components each associated with a different location around the second location, wherein the computer program code, when executed by the at least one processor, causes the apparatus:
when it is determined that the distance between the first and second locations is below a threshold, to cause provision of the virtual reality audio content to the user via the first user equipment such that sub-components of the virtual reality audio content appear to originate from different directions around the first user.

18. Apparatus according to claim 7, wherein the virtual reality content comprises audio content and wherein the computer program code, when executed by the at least one processor, causes the apparatus:
when it is determined that the distance between the first and second locations is below a threshold, to cause noise cancellation to be provided in respect of sounds other than the virtual reality audio content.

19. Apparatus according to claim 7, wherein the virtual reality content comprises audio content and wherein the computer program code, when executed by the at least one processor, causes the apparatus:
when it is determined that the distance between the first and second locations is above a threshold, to set a noise cancellation level in dependence on the distance between the first and second locations, such that a lower proportion of external noise is cancelled when the distance is greater than when the distance is less.

20. A computer-readable medium having computer-readable code stored thereon, the computer readable code, when executed by a least one processor, cause performance of at least:
causing provision of a first version of virtual reality content to a first user via first portable user equipment located at a first location and having a first orientation, the virtual reality content being associated with a second location and a second orientation, the first version of the virtual reality content being rendered for provision via the first user equipment in dependence on the first location relative to the second location and the first orientation relative to the second orientation.
